(19) United States
(12) Patent Application Publication
(10) Pub. No.: US 2010/0123414 A1
(43) Pub. Date: May 20, 2010

(54) Variable Lighting Zones

(75) Inventor: Nicholas A. Antonopoulos, San Jose, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/272,668

(22) Filed: Nov. 17, 2008

(51) Int. Cl. H05B 37/02

(52) U.S. Cl. 315/297

(57) ABSTRACT

A zoned lighting space (10) wherein an architectural space is divided in to a plurality of zones (16), each having its own sensor(s) and zone lights (18). The zone lights (18) are controlled by a controller (20) such that there are different lighting levels (55, 57, 59) depending upon whether a zone (16) is occupied, whether an adjacent zone (16) is occupied, whether some other zone (16) is occupied, and the like. A variable lighting control method (50) is adaptable such that fine control and adaptation for special circumstances can be achieved.

### BACKGROUND OF THE INVENTION

1. Field of the Invention

The present invention relates to the field electrical lighting and illumination, and more particularly to a method and means for conserving energy while maintaining a pleasant and desirable illumination level. The predominant current usage of the present inventive variable lighting zones method and apparatus is in the control of LED type lights, which are readily adaptable to instant changes in illumination level while delivering energy savings generally commensurate with lowered light levels.

2. Description of the Background Art

It is known in the art to save energy in lighting systems by using automatic sensors to sense the presence of a person and turn on the lights when a person is detected, and to turn them off when the person leaves, generally after a short delay period. This method is useful, as far as it goes, and is perfectly well suited to many applications.

However, there are many applications wherein it is undesirable to turn lights off even when they are not presently being used to illuminate the area for an occupant. While there might be many examples of such an application, one easily explained example would be that of a store or supermarket during off-peak hours such that not all of the aisles are occupied at any one time. It takes a tremendous amount of electricity to illuminate an entire super market continually, and many are open 24 hours a day. It would be a simple matter to put sensors in the aisles to turn off the lights in that aisle when there is no one present. However, that solution would be far less than desirable, since many people might be reluctant, consciously or even subconsciously, to enter into a darkened aisle, even if they knew that a light was supposed to come on if they did.

Clearly, it would be advantageous to find a way to provide reduced illumination, along with the attendant savings in power consumption that would be more pleasant and inviting than the present day automatic switches. However, to the inventor's knowledge, no satisfactory solution has been known prior to the present invention.

### SUMMARY

Accordingly, it is an object of the present invention to provide an apparatus and method for providing pleasant and useful illumination levels.

It is still another object of the present invention to provide an apparatus and method for reducing the amount of power needed to illuminate an area.

It is yet another object of the present invention to provide an apparatus and method for which is readily adaptable for use in a wide variety of applications.

Briefly, a known embodiment of the present invention is a controller for varying the lighting level individually in a plurality of zones. In the example given, the lighting zones are linear portions of a store aisle, although the invention is applicable to many other types of locations. The illumination level within each of the zones is controlled both by the presence of a person within such zone and by the proximity of a person or persons to each of such zones.

In this present example the illumination means is “LED” (light emitting diode) lighting, which lends itself well to instantaneous, rapid, or gradual changes in illumination level without loss of efficiency. Indeed, power savings are generally directly proportional to reduced illumination levels, as opposed to other types of lighting which may lose efficiency as illumination levels are reduced.

An example of a method which may be accomplished using a microprocessor is also provided.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the described objects and/or advantages. Accordingly, the objects and/or advantages described herein are not essential elements of the present invention, and should not be construed as limitations.

### BRIEF DESCRIPTION OF THE DRAWINGS

FIG. 1 is a diagrammatic to plan view of a store aisle, showing a plurality of illumination zones; and

FIG. 2 is a flow diagram showing an example of the present inventive method for controlling variable lighting zones.

### DETAILED DESCRIPTION OF THE INVENTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

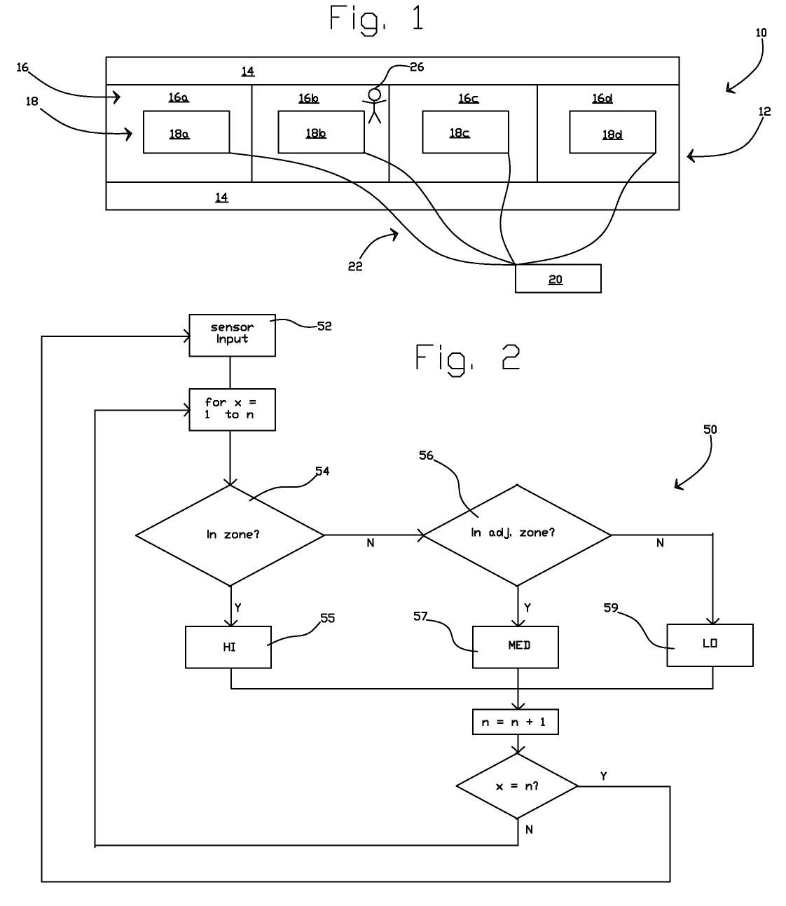

A known mode for carrying out the invention is accomplished by dividing a space into a plurality of variable lighting zones. The inventive divided lighting space is depicted in a top plan view in FIG. 1 and is designated therein by the general reference character 10. In this example, the lighting space 10 is a store aisle 12, such as an aisle of a supermarket, or the like, although other commercial areas, or even areas within a home might benefit from application of the present invention. Typically the aisle 12 which comprises the lighting space 10 of this example will be bordered by displays 12 which might include shelving, refrigerated storage displays, or the like.

As can be seen in the view of FIG. 1, the lighting space 10 is divided into a plurality (four, in this present example) of zones 14a, 14b, 14c and 14d. The quantity of zones 14 used for the present example is entirely arbitrary, and in practical applications, the size and quantity of zones will be selected to suit the application. Each of the zones 14 is serviced by a zone light 18a, 18b and 18c and 18d. While the zone lights 18 are depicted as being single separate units in example of the top plan view of FIG. 1, in practical applications each zone light 18 may consist of a plurality of separate lights. Alternatively, in some cases, the zone lights 18 may appear to the viewer to be one continuous light fixture running the length of the aisle 12. In short, the zone lights 18 can be configured, as required, to properly illuminate the lighting space 10. In any case, since in the present example the zone lights 10 use LED elements for illumination, it is likely that most zone lights 18 will each include a plurality of LED elements therein, such quantity being sufficient to provide the degree of illumination required.

A controller 20 individually controls the light levels of each zone light 18. A plurality of control lines 22 are shown in the view of FIG. 1 connecting the zone lights 18 to the controller. Also, for each zone 16 there is a sensor 24 that senses the presence of a person in each of the zones 16a, 16b, 16c and 16d. Although motion detectors are commonly used in such applications, any of several types of sensors 24 could be used to detect the presence of a person or persons within the zones 16. In order to avoid cluttering the drawing, sensor lines running from the sensors 24 to the controller 20 are omitted from the view of FIG. 1.

As can be appreciated by one skilled in the art, particularly in view of the discussion of the inventive method hereinafter, the controller 20 will have to be capable of a great many operations generally simultaneously in order to perform the necessary steps to control the lighting for even the single lighting space 10 described in this example. Furthermore, while the inventive method is described herein in relation to only a single aisle 12, in an actual application there may be a large plurality of such aisles 12 or other lighting spaces 10 to be controlled simultaneously, thereby even further requiring either a plurality of controllers 20 or a single controller 20 that possesses sufficient computing power to perform all of the calculations necessary to accomplish multiple iterations of the described inventive method. In the present example, a multi-core SEAforth™ processor, made by Intellasys™ is utilized for the purpose. One skilled in the art will readily be able to determine how much computing power will be required for a particular application.

FIG. 2 is a flow diagram depicting an example of the inventive variable lighting control method 50. The example of FIG. 2 employs quantities to correspond with the example of FIG. 1, and the inventive variable lighting control method 50 will be described, hereinafter, with reference both to FIG. 2 and to FIG. 1. As can be seen in the view of FIG. 2, in a “sensor input operation” 52 input (consisting of an indication as to whether or not a person or persons is present in each of the zones 16a, 16b, 16c and 16d) is provided from each of the sensors 24 to the controller 20. Then, for each of the zones 16 (in this example, for x=1 to n, where n=4) in an “in zone decision operation” 54 if there is a person or persons within the respective zone 16, then the illumination level of the corresponding zone light 18 will be set to high (Hi 56). If and only if there is no person in the respective zone 16, then in an “adjacent zone decision operation” 56 if there is a person or persons in any zone 16 adjacent to the zone 16 presently under consideration, then the illumination level of the corresponding zone light 18 will be set to a medium value (MED 57). If there is no person or persons either in the particular zone 18 under consideration nor in a zone 18 adjacent thereto, the illumination level of the corresponding zone light 18 will be set to a low value (LO 59). These decisions are iterated for each of the zones 18 and then, as can be seen in the view of FIG. 1, input is obtained from each of the sensors 24 to start the process again.

To illustrate by example the above operation, in the view of FIG. 1 a diagrammatic person 26 is illustrated in zone 16b, and no other persons 26 are present in the aisle 12. In this case, the zone light 18b would be set to high, the zone lights 16a and 16c would be set to a medium value, and the zone light 18d would be set to a low value.

Note that while the example illustrated by FIG. 2 shows one way to accomplish the desired objective, the essence of the present invention lies in the fact that a zone 18 with a person or persons therein will have a first (high) illumination level, a zone 18 with a person or persons in an adjacent zone will have a second (medium) lighting level, and zone with no person or persons in that zone or in adjacent zones will have a third (low) lighting level.

As stated above, the example of the inventive variable lighting control method 50 will be repeated, or else accomplished separately and generally simultaneously, for each lighting space 10 in the area to be illuminated and controlled.

In the present example, a Hi 55 illumination level will be essentially 100% of the illumination level of which each of the zone lights 18 is capable, MED 57 illumination level will be approximately 75%. And LO will be approximately 50%. However, it should be noted that these values are examples only. Indeed, in a particular application the values might be “tweaked” at very file levels to achieve the desired lighting effect. Indeed, one of the advantages for using a processor such as the Intellasys™ SEAforth™ chip is that the illumination of each zone 16 of each lighting space 10 can be individually controlled, as desired. As just one example, in some applications it might be decided that the proper level for LO 59 would be 0%.

It should be noted that, in this present example, no separate signal to voltage convertor(s) are shown, because it is assumed that such devices are embedded and are a part of each of the zone lights 18. However, it would also be possible, and even quite economical, to include such devices in the controller 20. Indeed, the Intellasys™ SEAforth™ processor, with a minimum of external components, could easily accomplish that task, as well.

Various modifications may be made to the invention without altering its value or scope. For example, while this invention has been described herein in terms of lighting the aisles 12 of a store, many other environments, such as homes, could benefit from the advantages provided by the present invention.

It should be remembered that the quantity of zones 16 illustrated herein (four) could be made greater or lesser, depending upon the size of the area to be illuminated, and such. Also, while the example of the present invention herein has been described as having only three gradient levels (Hi 55, MED 27 and LO 59) quite obviously there could be an even greater number of gradient levels such that lighting levels are calculated based not only on the presence of a person within a lighting zone and/or its immediate neighbors, but also upon the presence of a person within more distant neighbors. For example, an additional lighting level (between MED 57 and LO 59) could be provided where there is a person neither in the particular zone 18 nor in its immediate neighbor, but where there is a person in a zone 18 separated from the present zone 18 by one zone 18. A specific example of this, described in relation to the example of FIG. 1 would be that, if such additional gradient level were employed, then zone line 18d would be set to that level with the person 26 in zone 16b, as shown. This is, by no means, an exhaustive list of the possible variation of zones and gradients.

Another possible example of a variation of the present invention would be to set lighting levels to account for special circumstances. For example, if there were a particular product in the displays 14 of a particular zone 16, then the controller 20 could be programmed to set the illumination level a zone light 18 or zone lights 18 to highlight that particular zone 16. This could be done by raising the illumination level in that zone 18 higher than the “normal” condition, by lower the level of adjacent zones lower than that of the “normal” condition, or some such combination. (By “normal” what is meant here is the level that would be expected given the operation of the present inventive method described herein, if all zones 16 were treated equally.)

While specific examples of the inventive zoned lighting space 10 and variable lighting control method 50 have been discussed therein, it is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive zoned lighting space 10, and associated method 50 are intended to be widely used in a great variety of applications. It is expected that it they will be particularly useful in applications wherein both economy and having a pleasant and desirable illumination level are both important considerations. For example, in a store, it would be very uninviting to have the lights off in an aisle, but having a low, but pleasant level, might be even more inviting that a harsh, fully lit level. But as the customer approaches a particular area where he or she will need more light to clearly discern labels, and such, it will be provided. The same principles apply in the home. Instead of having lights suddenly coming on and going off, as with prior art motion detector lighting systems, the pleasant invention will provide a much more pleasant atmosphere—one that will probably actually be used instead of being turned off to avoid the unpleasant experience.

Since the zoned lighting space 10 and variable lighting control method 50 of the present invention may be readily produced and integrated with existing architectural spaces, and the like, and since the advantages as described herein are provided, it is expected that they will be readily accepted in the industry. For these and other reasons, it is expected that the utility and industrial applicability of the invention will be both significant in scope and long-lasting in duration.

I claim:

1. A lighting control system, comprising:
a plurality of zones;
a like plurality of lighting means such that each of said zones has its own lighting means;
a like plurality of sensors such that each zone has a sensor for determining if someone is present in said zone; and
a controller for individually controlling the level of light in each of said zones such that each zone will be illuminated at a first illumination level when it is occupied, at a third illumination level when it unoccupied but a neighboring zone is occupied, and at a third illumination level when neither itself nor a neighboring zone is occupied.

2. The lighting control system of claim 1, wherein:
the third illumination level is brighter than the second illumination level; and the second illumination level is brighter than the third illumination level.

3. The lighting control system of claim 1, wherein:
each of said lighting means is an LED light.

4. The lighting control system of claim 1, wherein:
each of said zones is a portion of a store aisle.

5. The lighting control system of claim 1, wherein:
each of said sensors is a motion detector.

6. A method for controlling lighting within an area, comprising:
dividing the area into a plurality of zones;
determining if someone is present in each of the zones; and
illuminating each of the zones at a first level if someone is present in the zone, at a second level is no one is present in that zone but someone is present in an adjacent zone, and at a third level if no one is present either in that zone or in an adjacent zone.

7. A method for controlling lighting within an area, comprising;
dividing the area into a plurality of zones;
determining if someone is present in each of the zones; and
illuminating each of the zones based on whether or not someone is present in the zone and also whether or not someone is present in at least one other such zone.

8. The method of claim 7, wherein:
said at least one other such zone includes a zone immediately adjacent to said zone.

9. The method of claim 7, wherein:
the area is a portion of a commercial facility.

10. The method of claim 7, wherein:
the area is a store aisle.

11. The method of claim 7, wherein:
each of said zones has a sensor for determining if someone is present therein.

12. The method of claim 11, wherein:
at least some of said plurality of sensors is a motion detector.

13. The method of claim 7, wherein:
each of said zones is illuminated by at least one lighting fixture.

14. The method of claim 13, wherein:
at least some of said lighting fixtures is an LED lamp.

15. The method of claim 7, wherein:
a controller sets the level for illuminating each of said zones based on input from the sensors.
